(19) United States
(12) Patent Application Publication
(10) Pub. No.: US 2019/0156250 A1
(43) Pub. Date: May 23, 2019

(54) METHOD AND SYSTEM FOR VEHICLE ALLOCATION

(71) Applicant: ANI TECHNOLOGIES PRIVATE LIMITED, Bengaluru (IN)

(72) Inventors: Moiaz Jiwani, Bilaspur (IN); Azimul Mannan, Bengaluru (IN)

(73) Assignee: ANI TECHNOLOGIES PRIVATE LIMITED

(21) Appl. No.: 15/917,100

(22) Filed: Mar. 9, 2018

(30) Foreign Application Priority Data
Nov. 23, 2017 (IN) 201741042083

(51) Int. Cl. G06Q 10/02; G06Q 50/30; G06F 17/30

(52) U.S. Cl. CPC G06Q 10/02; G06F 17/3087; G06F 17/30265; G06Q 50/30

(57) ABSTRACT

A method and a system for allocating a vehicle to a passenger for ride is provided. The system includes circuitry configured to receive an image corresponding to a booking request from a passenger device of the passenger. In response to the received image, the circuitry determines the destination address of the booking request based on the received image. The circuitry further displays the received image and the determined destination address of the booking request on a display of the passenger device. In response to the displayed image and destination address, the circuitry receives a confirmation message from the passenger device, and allocates the vehicle to the passenger based on the received confirmation message.

### CROSS-RELATED APPLICATIONS

This application claims priority of Indian Application Serial No. 201741042083, filed Nov. 23, 2017, the contents of which are incorporated herein by reference.

### FIELD OF THE INVENTION

The present invention relates generally to a vehicle allocation system, and more particularly, to a system and method for allocating a vehicle to a passenger for a ride based on inputs provided by the passenger.

### BACKGROUND

With improvements in lifestyle of individuals and limited alternatives of public or private transportations, popularity of cab services is continuously increasing for travelling between source and destination locations. Further, with advancements in mobile technology, smart mobile devices are increasingly being used by the individuals for various purposes as per daily requirements. For example, a passenger may use a smartphone to book a cab for a ride by means of a cab booking application installed on the smartphone. During such process of booking the cab, the passenger provides travel-related text details, for example, source information, destination information, a time of travel, and the like, by means of the installed application on the smartphone. For example, the passenger uses one or more input devices, such as a keypad, a keyboard, a virtual keypad, and the like, to input the travel -related text details on a cab booking interface of the installed application. Based on the travel -related details and an availability of the cab, the cab is allocated to the passenger for the ride. Booking the vehicle using the installed application on the smartphone may seem as a trivial task for many passengers, yet there are other passengers, for example, older or illiterate passengers, who can struggle with such booking system. Such other passengers may not be able to enter implicit information related to their rides. Furthermore, it can be a problem for the passenger, with ordinary skill in the art, to book the vehicle if he (or she) does not know the address of the destination.

To encounter such problems, a cab booking system may show suggestions in the form of various addresses according to one or more keywords entered by the passengers. However, it can still be a problem for the passengers who are not tech savvy or the passengers who have no information on the one or more keywords. Hence, the overall booking experience of the passengers may further be compromised. This can become very inconvenient and troublesome for the passengers who are in need for the rides.

Since the mobile technology is continuously being utilized to manage and support the booking of the cabs, a continuing need exists in the art for improved methods and systems for facilitating the booking of the cabs.

### SUMMARY

In an embodiment of the present invention, a system for allocating a vehicle to a passenger for a ride is provided. The system includes circuitry to perform various operations. The circuitry is configured to receive an image corresponding to a destination address of a booking request for the vehicle. The booking request is received from a passenger device of a passenger via a communication network. The circuitry is further configured to determine the destination address of the booking request based on the received image. The circuitry is further configured to display the received image and the determined destination address on a display of the passenger device. The circuitry is further configured to receive a confirmation message of the booking request based on the displayed image and destination address from the passenger device over the communication network. In response to the received confirmation message, the circuitry is further configured to allocate the vehicle to the passenger for the ride.

In another embodiment of the present invention, a method for allocating a vehicle to a passenger for a ride is provided. The method comprises receiving, by a server, an image corresponding to a destination address of a booking request for the vehicle. The image is received from a passenger device of the passenger over a communication network. The method further comprises determining, by the server, the destination address of the booking request based on the received image. The method further comprises displaying, by the server, the received image and the determined destination address of the booking request on a display of the passenger device. The method further comprises receiving, by the server, a confirmation message of the booking request based on the displayed image and destination address. The confirmation message is received from the passenger device over the communication network. In response to the received confirmation message, the vehicle is allocated to the passenger for the ride.

Various embodiments of the present invention provide a method and system for allocating a vehicle to a passenger for a ride. The server receives a booking request from a passenger device of the passenger via a communication network. The booking request corresponds to a request for booking the vehicle for the ride. The booking request includes an image corresponding to a destination address of the ride. The booking request may further include other ride-related details, such as a source address, a time of travel, or a type of the vehicle. The image received by the server is selected by the passenger from one or more libraries of images. In an embodiment, the server provides a first library of images during the booking request by the passenger, on the passenger device over the communication network. The server may receive the image selected by the passenger from the first library of images over the communication network. In another embodiment, the server provides a second library of images during the booking request by the passenger, on the passenger device over the communication network. Each image of the second library of images is associated with a corresponding destination address that has been defined by the passenger prior to the booking request.

The server may receive the image selected by the passenger from the second library of images over the communication network. In another embodiment, the server receives the image from the passenger device over the communication network that has been selected by the passenger from a third library of images. The third library of images includes one or more images that are stored in the memory of the passenger device. In another embodiment, the server receives the image that is a preview image by an image-capturing device of the passenger device. The passenger provides an input to display the preview image by means of the image capturing device. After receiving the image corresponding to the destination address of the booking request, the server determines the destination address of the booking request. The destination address is determined based on the received image. In an embodiment, the server may determine the destination address by executing one or more image-based web portal searches based on the received image. In another embodiment, the server may extract geo-tag information from the received image to determine the destination address of the booking request. In another embodiment, the server may extract pre-configured information from the received image to determine the destination address of the booking request. Further, the server displays the received image and the determined destination address of the booking request on a display of the passenger device. The server further receives a confirmation message of the booking request based on the displayed image and destination address from the passenger device over the communication network. Based on at least the received confirmation message, the server allocates the vehicle to the passenger for the ride. Based on such applications provided by a cab service provider, the cab booking by the passenger is simplified, and enhances the overall service experience for the passenger.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates a system environment for allocating a vehicle to a passenger for a ride, in accordance with an embodiment of the present invention;

FIG. 2 is a block diagram that illustrates a passenger device and an application server of the system environment of FIG. 1, in accordance with an embodiment of the present invention;

FIGS. 3, 4 and 5 illustrate exemplary user interfaces on a passenger device for selecting an image corresponding to a destination address by a passenger, in accordance with an embodiment of the present invention;

FIG. 6 illustrates a flow chart of a method for allocating a vehicle to a passenger for a ride, in accordance with an embodiment of the present invention; and

FIG. 7 illustrates a block diagram of a computer system for allocating a vehicle to a passenger for a ride, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes a system for allocating a vehicle to a passenger for a ride. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

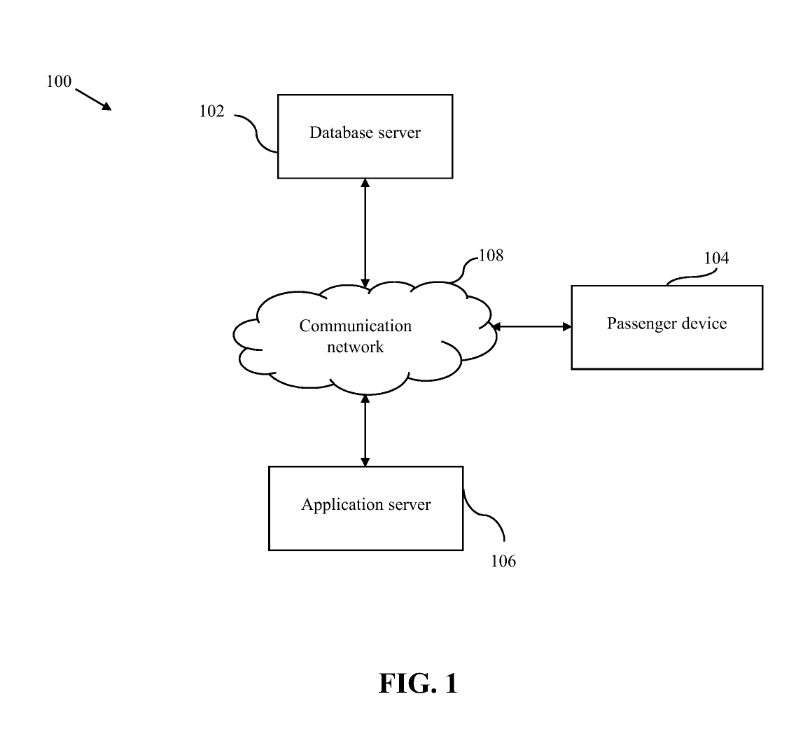

Referring now to FIG. 1, a system environment 100 for allocating a vehicle to a passenger for a ride is shown, in accordance with an embodiment of the present invention. The system environment 100 includes at least a database server 102, a passenger device 104 and an application server 106. The passenger device 104 communicates with the database server 102 and the application server 106 over a communication network 108. Examples of the communication network 108 include, but are not limited to, a wireless fidelity (Wi-Fi) network, a light fidelity (Li-Fi) network, a satellite network, an internet, a mobile network such as cellular data, high speed packet access (HSPA), or any combination thereof.

The database server 102 is a content management and storage server that manages and stores image content of various source and destination locations, such as tourist spots, monuments, hotels, commercial buildings, residential buildings, and the like. The database server 102 further manages and stores historical travel data of passengers. The database server 102 includes a processor (not shown) and a memory (not shown) for managing and storing the image content and the historical travel data. The processor of the database server 102 extracts the image content from various image content platforms based on an authentication with the content image platforms. The processor stores the extracted media content in the memory of the database server 102. The processor of the database server 102 further receives the historical travel data of the passengers from passenger devices of the passengers via the communication network 108 based on historical travel requests by the passengers. The processor stores the received historical travel data in the memory of the database server 102. The database server 102 further communicates with the application server 106, via the communication network 108. For example, the database server 102 may receive a query, from the application server 106 over the communication network 108, to retrieve at least one of first and second library of images from stored image content. The database server 102, in response to the received query from the application server 106, transmits at least one of the first and second library of images to the application server 106 over the communication network 108. The first library of images may include one or more images of one or more locations (for example, the source and destination locations) that have been tagged with corresponding geo-tag information, such as latitude and longitude information, by the application server 106. The second library of images may include one or more images of the one or more locations (for example, the source and destination locations) that have been configured with a corresponding source or destination address, and stored in the memory of the database server 102 by the passengers in the past. Examples of the database server 102 include, but are not limited to, a personal computer, a laptop, or a network of computer systems.

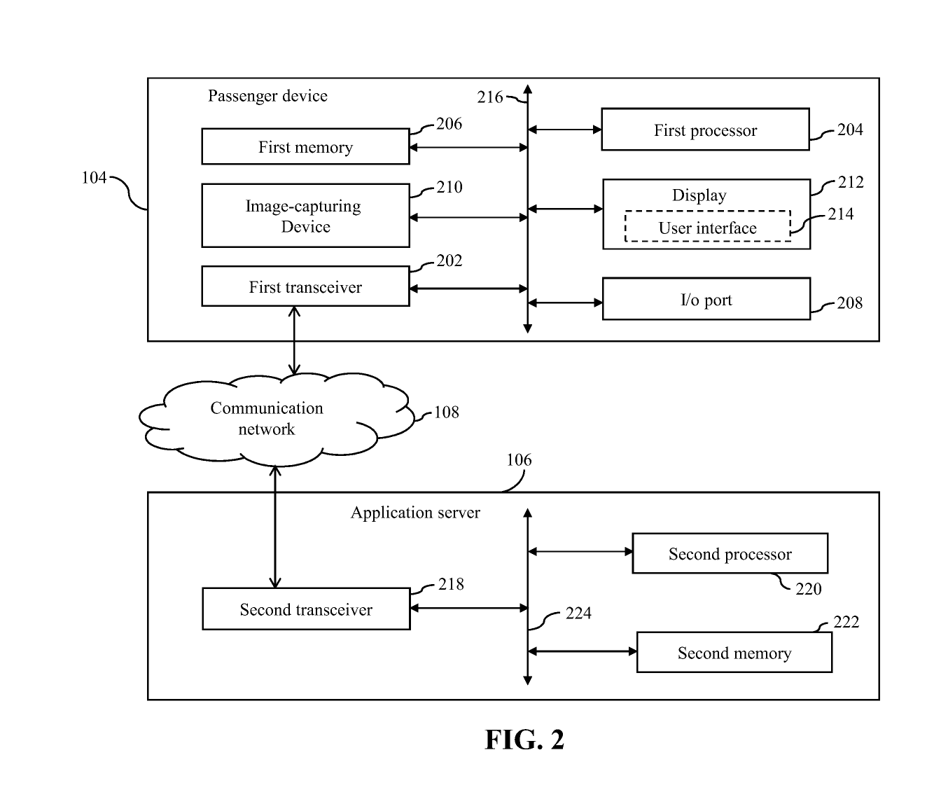

The passenger device 104 corresponds to a computing device that is utilized by the passenger to perform one or more activities. For example, the passenger utilizes the passenger device 104 to schedule the ride between a plurality of locations including source and destination locations by means of a service application installed on the passenger device 104. To schedule the ride, the passenger inputs details of a booking request including at least one of a source address of the source location or a destination address of the destination location through the installed service application. The passenger may provide the booking details by uploading the one or more images corresponding to at least one of the source or destination locations onto the application server 106 by means of the installed service application. In a scenario where a pick-up location of the passenger is the same as the source location, the passenger may not upload any image corresponding to the source location. The source address of the source location may be automatically captured by the application server 106 based on Global Positioning System (GPS) information transmitted by the passenger device 104 over the communication network 108. In such a case, the passenger may only select and upload an image corresponding to the destination location by means of the installed service application. However, if the pick-up location is not the same as the source location, the passenger may select and upload a first image corresponding to the source location and a second image corresponding to the destination location. In an embodiment, the passenger may select the one or more images corresponding to at least one of the source or destination locations from at least one of the first or second library of images provided by the application server 106 on the passenger device 104 through the installed service application. In another embodiment, the passenger may select the one or more images corresponding to at least one of the source or destination locations from a third library of images that are stored in a local memory of the passenger device 104. In another embodiment, the passenger may provide an input to display a preview image corresponding to at least one of the source or destination locations by means of an imaging sensor of the passenger device 104. Examples of the passenger device 104 include, but are not limited to, a personal computer, a laptop, a smartphone, and a tablet computer. The passenger device 104 has been described in detail in conjunction with FIG. 2.

The application server 106 corresponds to a computing device, a software framework, or a combination thereof, that may provide a generalized approach to create the application server implementation. In an embodiment, the operation of the application server 106 may be dedicated to execution of procedures, such as, but are not limited to, programs, routines, or scripts stored in one or more memories for supporting its applied applications. In an embodiment, the application server 106 receives the booking request including the one or more images from the passenger device 104 over the communication network 108. The one or more images may correspond to at least one of the source or destination locations. The application server 106 may execute one or more image processing techniques, known in the art, to process the one or more images to determine at least one of the source or destination locations and the corresponding addresses. Further, the application server 106 may render a graphical user interface (GUI) on the passenger device 104. The GUI may include at least the received one or more images and the corresponding one or more addresses. The application server 106 may receive, in response to the rendered GUI, a confirmation message corresponding to the booking request from the passenger device 104 over the communication network 108. Based on the received confirmation message, the application server 106 may execute an allocation process to allocate the vehicle that is available for the ride (or may be available in a near future time) to the passenger. The application server 106 may be realized through various web-based technologies such as, but not limited to, a Java web-framework, a .NET framework, a PHP framework, or any other web-application framework. The various operations of the application server 106 have been described in detail in conjunction with FIG. 2.

Hereinafter, various embodiments of the invention have been described considering the automatic capturing of the source address of the source location based on the GPS information from the passenger device 104, and thereby, executing the allocation of the vehicle to the passenger by determining the destination address of the destination location based on the received image corresponding to the destination location from the passenger device 104. However, a person having ordinary skills in the art would understand that the scope of the invention is not limited to the allocation of the vehicle by determining the destination address based on the received image. Similar processes may be executed by the application server 106 to allocate the vehicle to the passenger by determining the source address based on the received image corresponding to the source location from the passenger device 104, without limiting the scope of the invention.

Referring now to FIG. 2, the passenger device 104 and the application server 106 of the system environment 100 are shown, in accordance with an embodiment of the present invention. The passenger device 104 communicates with the application server 106 over the communication network 108. The passenger device 104 includes circuitry, such as a first transceiver 202, a first processor 204, a first memory 206, an input/output (I/O) port 208, an image-capturing device 210, and a display 212 comprising a graphical user interface (GUI) such as a user interface 214. The first transceiver 202, the first processor 204, the first memory 206, the I/O port 208, the image-capturing device 210, and the display 212 may communicate with each other by way of a first bus 216, as shown. The application server 106 includes circuitry, such as a second transceiver 218, a second processor 220 and a second memory 222. The second transceiver 218, the second processor 220 and the second memory 222 may communicate with each other by way of a second bus 224, as shown.

The first transceiver 202 includes suitable logic, circuitry, and/or interfaces that are operable to execute one or more instructions stored in the first memory 206 to perform one or more operations. For example, the first transceiver 202 transmits (or receives) data to (or from) various devices, such as the second transceiver 218 of the application server 106. The first transceiver 202 communicates with the second transceiver 218 over the communication network 108. The first transceiver 202 further transmits the image corresponding to the destination address of the booking request for the vehicle provided by the passenger through the I/O port 208 to the second transceiver 218. In response to the booking request, the first transceiver 202 receives the image and the destination address determined from the image, from the second transceiver 218. Examples of the first transceiver 202 include, but are not limited to, an antenna, a radio frequency transceiver, a wireless transceiver, and a Bluetooth transceiver. The first transceiver 202 communicates with the second transceiver 218 using various wired and wireless communication protocols, such as, but are not limited to, TCP/IP, UDP, 2G, 3G, 4G communication protocols, or any combination thereof.

The first processor 204 includes suitable logic, circuitry, and/or interfaces that are operable to execute one or more instructions stored in the first memory 206 to perform one or more operations. For example, the first processor 204 selects the image corresponding to the destination address of the booking request based on the input provided by the passenger through the I/O port 208. The first processor 204 further renders the user interface 214 on the display 212 comprising at least the image and the destination address determined from the image by the second processor 220. Examples of the first processor 204 include an application-specific integrated circuit (ASIC) processor, a reduced instruction set computing (RISC) processor, a complex instruction set computing (CISC) processor, a field-programmable gate array (FPGA), and the like. It will be apparent to a person skilled in the art that the first processor 204 may be compatible with multiple displays, for example, the display 212 of the passenger device 104.

The first memory 206 includes suitable logic, circuitry, and/or interfaces to store images, such as the third library of images. Further, the first memory 206 may temporarily store the first and second library of images provided by the application server 106 in response to the booking request. The first memory 206 further stores the one or more instructions that are executable by the first transceiver 202, the first processor 204, the I/O port 208, the image-capturing device 210, and the display 212 to perform the corresponding one or more operations. Examples of the first memory 206 include a random access memory (RAM), a read-only memory (ROM), a programmable ROM (PROM), an erasable PROM (EPROM), a Hard Disk Drive (HDD), and a Secure Digital (SD) card, and the like.

The I/O port 208 includes suitable logic, circuitry, and/or interfaces that are operable to execute one or more instructions stored in the first memory 206 to perform one or more operations. For example, by means of the I/O port 208, the passenger of the passenger device 104 may provide inputs to perform the one or more operations. For example, the passenger may provide the inputs for starting the installed service application on the passenger device 104, selecting the image corresponding to the destination address, providing the confirmation message, and the like by means of the I/O port 208. The passenger may further provide the inputs for initializing the image-capturing device 210 for displaying the preview of the image. Examples of the I/O port 208 include a universal serial bus (USB) port, an Ethernet port, a real or virtual keypad, a mouse, a stylus, and the like.

The image-capturing device 210 includes suitable logic, circuitry, and/or interfaces that are operable to execute one or more instructions stored in the first memory 206 to perform one or more operations. For example, the image-capturing device 210 displays the preview of the one or more images on the display 212 based on the inputs provided by the passenger. The image-capturing device 210 further captures the one or more images, and stores the one or more captured images in the first memory 206. The image-capturing device 210 includes one or more image sensors, such as, but are not limited to, a complementary metal oxide semiconductor (CMOS) image sensor, a charge coupled device (CCD) image sensor, and the like that captures the one or more images.

The display 212 includes suitable logic, circuitry, and/or interfaces that are operable to execute one or more instructions stored in the first memory 206 to perform one or more operations. For example, the display 212 displays the image and the destination address determined from the image by the application server 106 on the user interface 214. The display 212 further displays at least one of driver details, vehicle details, and a current status of the allocated vehicle to the passenger provided by the application server 106. Examples of the display 212 include TFT LCD, IPS LCD, Resistive Touchscreen LCD, Capacitive Touchscreen LCD, OLED, AMOLED, Super AMOLED, Retina Display, Haptic/Tactile touchscreen, Gorilla Glass, and the like.

The second transceiver 218 includes suitable logic, circuitry, and/or interfaces that are operable to execute one or more instructions stored in the second memory 222 to perform one or more operations. For example, the second transceiver 218 communicates with the database server 102 to retrieve at least one of the first or second library of images over the communication network 108. The second transceiver 218 receives the booking request comprising the image corresponding to the destination address of the booking request from the passenger device 104. The second transceiver 218 communicates with the first transceiver 202 over the communication network 108. The second transceiver 218 further transmits the image and the destination address determined from the image to the first transceiver 202. The second transceiver 218 further receives the confirmation message from the first transceiver 202 of the passenger device 104. The second transceiver 218 further transmits the driver details, the vehicle details, and the current status of the allocated vehicle to the first transceiver 202. Examples of the second transceiver 218 include, but are not limited to, an antenna, a radio frequency transceiver, a wireless transceiver, and a Bluetooth transceiver. The second transceiver 218 communicates with the database server 102 and the first transceiver 202 using various wired and wireless communication protocols, such as TCP/IP, UDP, 2^{nd} Generation (2G), 3^{rd} Generation (3G), 4^{th} Generation (4G) communication protocols, or any combination thereof.

The second processor 220 includes suitable logic, circuitry, and/or interfaces that are operable to execute one or more instructions stored in the second memory 222 to perform one or more operations. For example, the second processor 220 provides at least one of the first or second library of images on the passenger device 104, from which the passenger selects the image corresponding to the destination address for booking the vehicle for the ride. In another example, the passenger may select the image from the third library of images stored in the first memory 206 of the passenger device 104. In another example, the passenger may provide the input to display the preview image of the destination location by means of the image-capturing device 210 that is selected as the image corresponding to the destination address. In response to the selected image, the second processor 220 receives and processes the image to determine the destination address corresponding to the received image. In an embodiment, the second processor 220 determines the destination address of the booking request by executing one or more image-based web portal searches (for example, Google image search). In another embodiment, the second processor 220 determines the destination address of the booking request by extracting the geo-tag information from the received image. In another embodiment, the second processor 220 determines the destination address of the booking request by extracting pre-configured information from the received image. After determining the destination address of the booking request based on the received image, the second processor 220 displays the received image and the determined destination address on the display 212 of the passenger device 104. Further, the second processor 220 receives the confirmation message from the passenger device 104, and allocates the vehicle to the passenger for the requested ride. Examples of the second processor 220 include an ASIC processor, a RISC processor, a CISC processor, an FPGA, and the like.

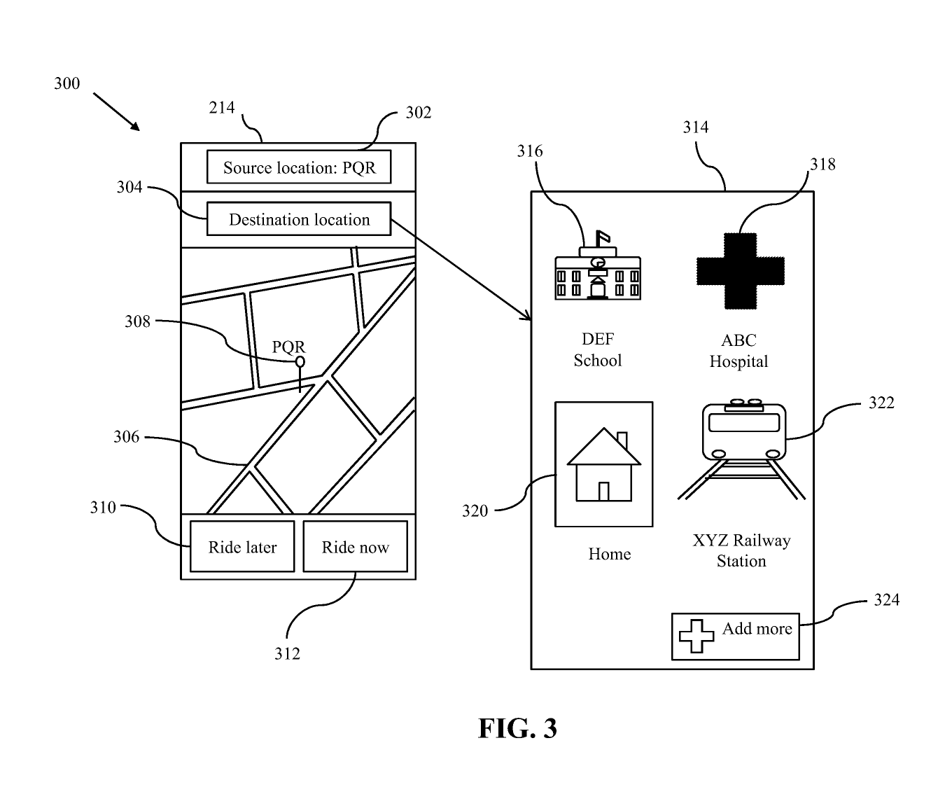

Referring now to FIG. 3, a first exemplary user interface 300 on the passenger device 104 for selecting the image corresponding to the destination address by the passenger is shown, in accordance with an embodiment of the present invention. The first exemplary user interface 300 corresponds to the user interface 214 rendered by the application server 106 on the passenger device 104 over the communication network 108. In an exemplary scenario, the user interface 214 is rendered on the display 212 of the passenger device 104 over the communication network 108, when the passenger opens the installed service application on the passenger device 104 for initiating the booking request for the vehicle. The user interface 214 includes at least a source location section 302, a destination location section 304, a roadway network map 306, a captured source location 308, a ride later tab 310 and a ride now tab 312. Based on the captured source location 308 using the GPS information of the passenger device 104, the second processor 220 displays the source address (e.g., “PQR”) of the captured source location 308 in the source location section 302, as shown. Further, the passenger may provide the input to select the destination location section 304 for providing the destination address of the booking request. In response to the selection of the destination location section 304, the second processor 220 provides a pop-up window, such as a first window 314, on the user interface 214. The first window 314 may include at least one of the first or second library of images comprising the one or more images, such as a first image (“DEF school”) 316, a second image (“ABC hospital”) 318, a third image (“HOME”) 320, and a fourth image (“XYZ railway station”) 322. The passenger may further provide the input to select the image corresponding to the destination address from at least one of the first or second library of images. In a scenario where a preferred image corresponding to the destination address is not available in the first or second library of images, the passenger may select an add more tab 324 on the first window 314 to add the preferred image in at least one of the first or second library of images, and selects the added image as the image corresponding to the destination address. The first transceiver 202 under the control of the first processor 204 transmits the selected image corresponding to the destination address to the application server 106 over the communication network 108. The second transceiver 218 of the application server 106 receives the selected image, and stores the received image in the second memory 222. The second processor 220 processes the received image to determine the destination address of the booking request. In one embodiment, the second processor 220 extracts the geo-tag information from the received image, and determines the destination address of the booking request based on the extracted geo-tag information, when the received image corresponds to the first library of images. In another embodiment, the second processor 220 extracts the pre-configured information from the received image, and determines the destination address of the booking request based on the extracted pre-configured information. In another embodiment, the second processor 220 executes the one or more image-based web portal searching based on the received image, and determines the destination address of the booking request. Further, the second processor 220 displays the received image and the determined destination address on the user interface 214 rendered on the display 212 of the passenger device 104. In response, the passenger provides the input to confirm the received image and the determined destination address. The second processor 220 receives the confirmation message, and allocates the vehicle to the passenger for the ride based on the received confirmation message.

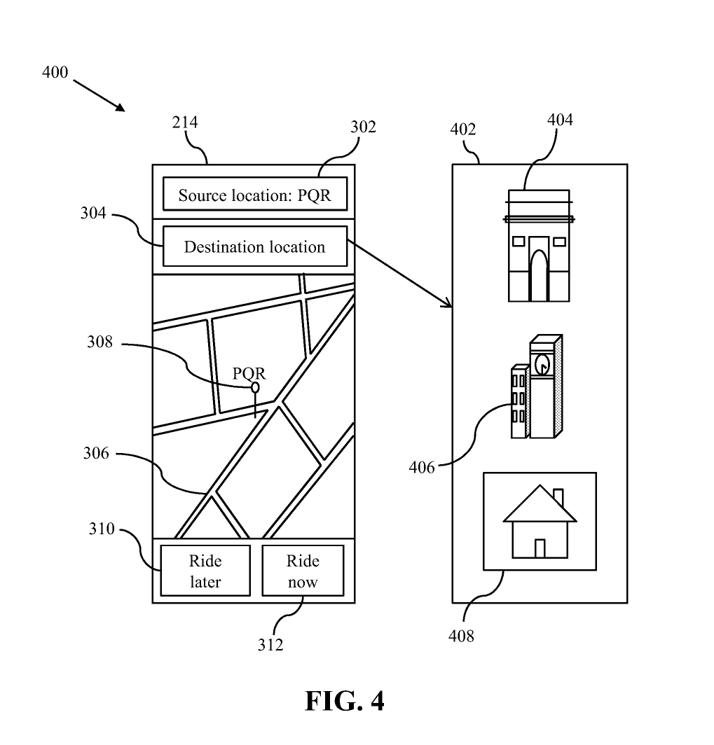

Referring now to FIG. 4, a second exemplary user interface 400 on the passenger device 104 for selecting the image corresponding to the destination address by the passenger is shown, in accordance with an embodiment of the present invention. The second exemplary user interface 400 corresponds to the user interface 214 rendered by the application server 106 on the passenger device 104 over the communication network 108. In an exemplary scenario, the user interface 214 is rendered on the display 212 of the passenger device 104 over the communication network 108, when the passenger opens the installed service application on the passenger device 104 for initiating the booking request for the vehicle. The user interface 214 includes at least the source location section 302, the destination location section 304, the roadway network map 306, the captured source location 308, the ride later tab 310 and the ride now tab 312. Based on the captured source location 308 using the GPS information of the passenger device 104, the second processor 220 displays the source address (e.g., “PQR”) of the captured source location 308 in the source location section 302, as shown. Further, the passenger may provide the input to select the destination location section 304 for providing the destination address of the booking request. In response to the selection of the destination location section 304, the passenger may browse the first memory 206 to view a pop-up window, such as a second window 402, on the user interface 214. The second window 402 may include the third library of images comprising the one or more images, such as a first image 404, a second image 406, and a third image 408, which are stored in the first memory 206 of the passenger device 104. The passenger may further provide the input to select the image corresponding to the destination address from the third library of images. The first transceiver 202 under the control of the first processor 204 transmits the selected image corresponding to the destination address to the application server 106 over the communication network 108. The second transceiver 218 of the application server 106 receives the selected image, and stores the received image in the second memory 222. The second processor 220 processes the received image to determine the destination address of the booking request. In one embodiment, the second processor 220 extracts the geo-tag information from the received image, and determines the destination address of the booking request based on the extracted geo-tag information, when the received image corresponds to the first library of images. In another embodiment, the second processor 220 extracts the pre-configured information from the received image, and determines the destination address of the booking request based on the extracted pre-configured information. In another embodiment, the second processor 220 executes the one or more image-based web portal searching based on the received image, and determines the destination address of the booking request. Further, the second processor 220 displays the received image and the determined destination address on the user interface 214 rendered on the display 212 of the passenger device 104. In response, the passenger provides the input to confirm the received image and the determined destination address. The second processor 220 receives the confirmation message, and allocates the vehicle to the passenger for the ride based on the received confirmation message.

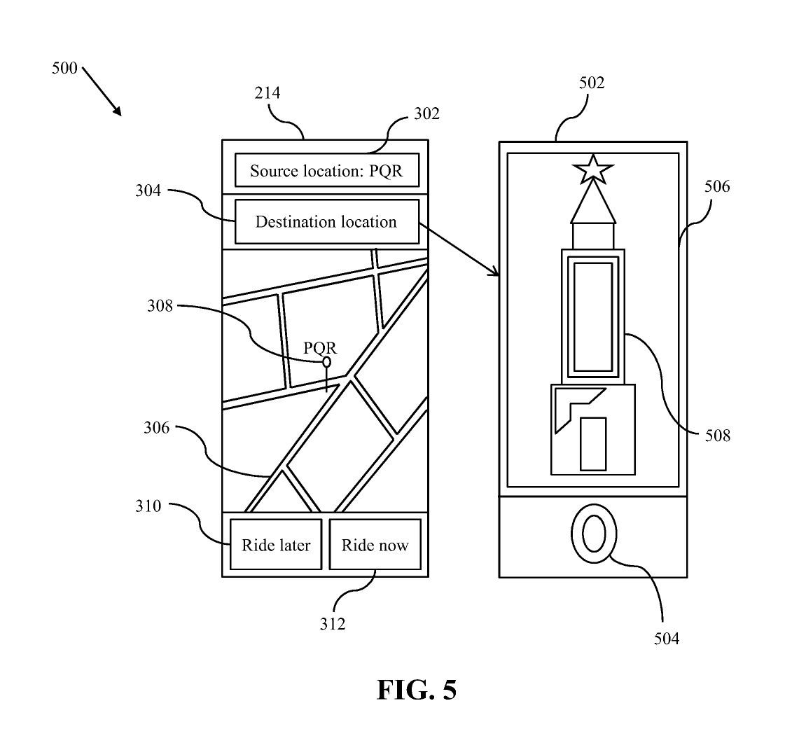

Referring now to FIG. 5, a third exemplary user interface 500 on the passenger device 104 for selecting the image corresponding to the destination address by the passenger is shown, in accordance with an embodiment of the present invention. The third exemplary user interface 500 corresponds to the user interface 214 rendered by the application server 106 on the passenger device 104 over the communication network 108. In an exemplary scenario, the user interface 214 is rendered on the display 212 of the passenger device 104 over the communication network 108, when the passenger opens the installed service application on the passenger device 104 for initiating the booking request for the vehicle. The user interface 214 includes at least the source location section 302, the destination location section 304, the roadway network map 306, the captured source location 308, the ride later tab 310 and the ride now tab 312. Based on the captured source location 308 using the GPS information of the passenger device 104, the second processor 220 displays the source address (e.g., “PQR”) of the captured source location 308 in the source location section 302, as shown. Further, the passenger may provide the input to select the destination location section 304 for providing the destination address of the booking request. In response to the selection of the destination location section 304, the passenger may provide the input to switch-on the image-capturing device 210 (e.g., a camera of the passenger device 104). In response, the first processor 204 present a camera window, such as a third window 502 including at least a capture tab 504 for capturing the image and an image preview interface 506 for displaying the preview of the image. The passenger may project the image-capturing device 210 onto a desired object 508 corresponding to the destination address to obtain an image preview of the desired object 508 on the image preview interface 506. The second processor 220 may identify the previewed image as the image corresponding to the destination address of the booking request. The second transceiver 218 of the application server 106 receives the identified previewed image, and stores the received image in the second memory 222. The second processor 220 processes the received image to determine the destination address of the booking request. In an embodiment, the second processor 220 executes the one or more image-based web portal searching based on the received image, and determines the destination address of the booking request. Further, the second processor 220 displays the received image and the determined destination address on the user interface 214 rendered on the display 212 of the passenger device 104. In response, the passenger provides the input to confirm the received image and the determined destination address. The second processor 220 receives the confirmation message, and allocates the vehicle to the passenger for the ride based on the received confirmation message.

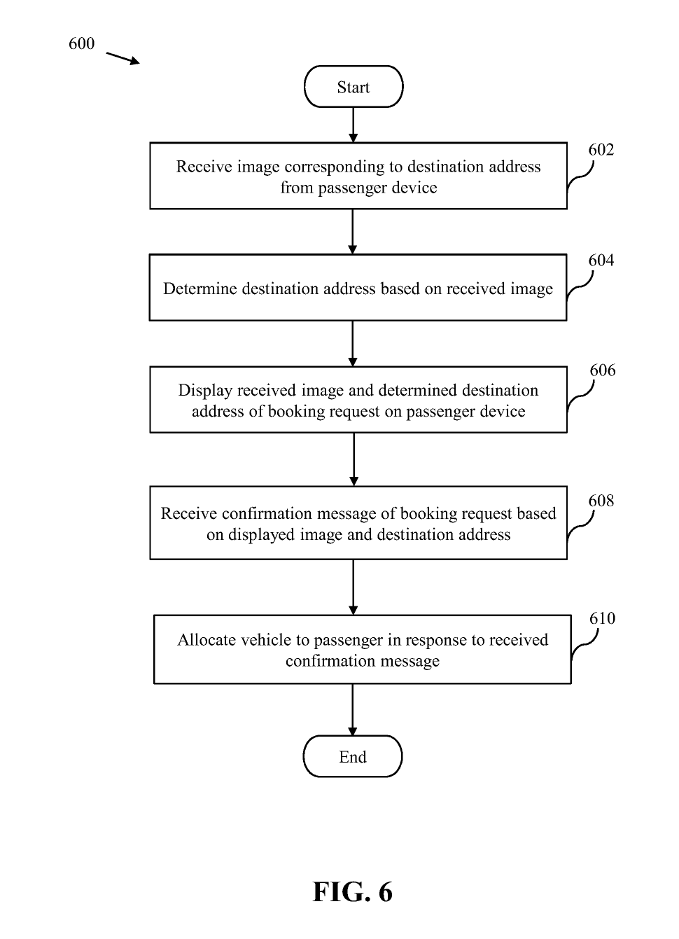

Referring now to FIG. 6, a flow chart 600 that illustrates a method for allocating the vehicle to the passenger for the ride is shown, in accordance with an embodiment of the present invention.

At step 602, the second transceiver 218 of the application server 106 receives the image corresponding to the destination address from the passenger device 104 over the communication network 108. The first transceiver 202 transmits the image selected by the passenger to the second transceiver 218 over the communication network 108. In an embodiment, the passenger may select the image from at least one of the first, second, or third library of images. The first or second library of images includes the one or more images that are provided by the application server 106 on the passenger device 104 during the booking request by means of the installed service application. The third library of images includes the one or more images that are stored in the first memory 206 of the passenger device 104. In another embodiment, the passenger may provide the preview image of the desired object as the image corresponding to the destination address. After receiving the image corresponding to the destination address from the passenger device 104, the second transceiver 218 stores the received image in the second memory 222.

At step 604, the second processor 220 determines the destination address of the booking request based on the received image. The second processor 220 may execute the one or more image-based web searching of the received image or the one or more image -processing techniques on the received image to determine the destination address. Further, the second processor 220 may extract the geo-tag information or the pre-configured information from the received image to determine the destination address.

At step 606, the second processor 220 displays the received image and the determined destination address on the display 212 of the passenger device 104. The second processor 220 may render the user interface 214 on the display 212 by means of the installed service application to display the received image and the determined destination address.

At step 608, the second transceiver 218 receives the confirmation message of the booking request from the passenger device 104 over the communication network 108. Based on the displayed image and destination address, the passenger provides the input to confirm the booking request, which is transmitted as the confirmation message to the second transceiver 218 by the first transceiver 202 over the communication network 108. The second transceiver 218 receives the confirmation message, and stores the received confirmation message in the second memory 222.

At step 610, the second processor 220 allocates the vehicle to the passenger. The vehicle is allocated to the passenger in response to the received confirmation message provided by the passenger.

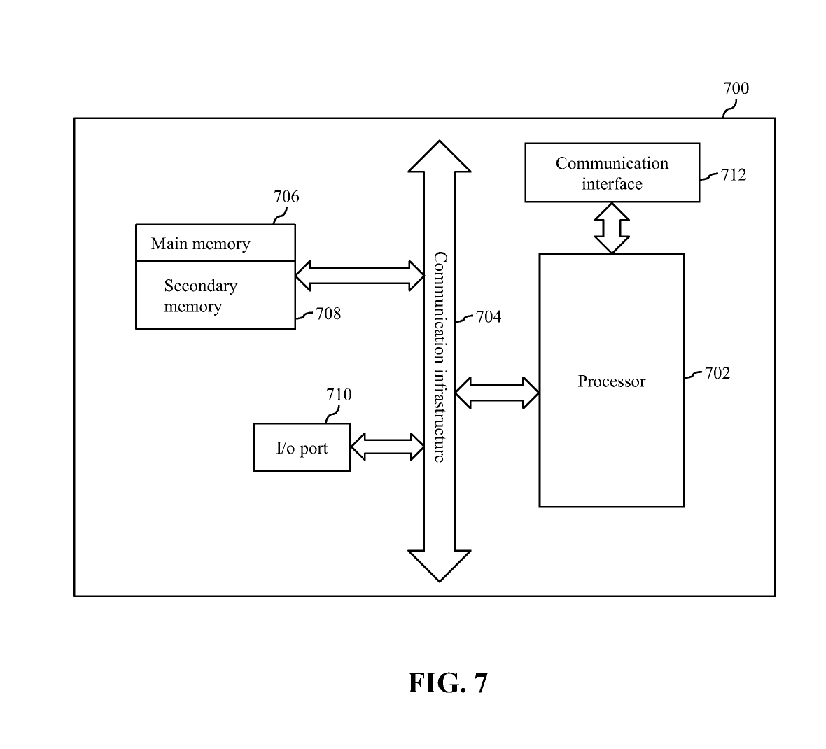

Referring now to FIG. 7, a block diagram of a computer system 700 for allocating the vehicle to the passenger for the ride is shown, in accordance with an embodiment of the present invention. An embodiment of the present invention, or portions thereof, may be implemented as computer readable code on the computer system 700. In one example, the database server 102 and the application server 106 of FIG. 1 may be implemented in the computer system 700 using hardware, software, firmware, non-transitory computer readable media having instructions stored thereon, or a combination thereof, and may be implemented in one or more computer systems or other processing systems. Hardware, software, or any combination thereof may embody modules and components used to implement the method of FIG. 6.

The computer system 700 includes a processor 702 that may be a special purpose or a general purpose processing device. The processor 702 may be a single processor, multiple processors, or combinations thereof The processor 702 may have one or more processor “cores.” Further, the processor 702 may be connected to a communication infrastructure 704, such as a bus (e.g., the first or second bus 216 or 224), a bridge, a message queue, a network (e.g., the communication network 108), multi-core message-passing scheme, and the like. The computer system 700 further includes a main memory 706 and a secondary memory 708. Examples of the main memory 706 may include random access memory (RAM), read-only memory (ROM), and the like. The secondary memory 708 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 700 further includes an input/output (I/O) port 710 and a communication interface 712. The I/O port 710 includes various input and output devices that are configured to communicate with the processor 702. Examples of the input devices may include a keyboard, a mouse, a joystick, a touchscreen, a microphone, and the like. Examples of the output devices may include a display screen, a speaker, headphones, and the like. The communication interface 712 may be configured to allow data to be transferred between the computer system 700 and various devices that are communicatively coupled to the computer system 700. Examples of the communication interface 712 may include a modem, a network interface, i.e., an Ethernet card, a communications port, and the like. Data transferred via the communication interface 712 may correspond to signals, such as electronic, electromagnetic, optical, or other signals as will be apparent to a person skilled in the art. The signals may travel via a communications channel, such as the communication network 108, which may be configured to transmit the signals to devices that are communicatively coupled to the computer system 700. Examples of the communication channel may include cable, fiber optics, a phone line, a cellular phone link, a radio frequency link, a wireless link, and the like.

Computer program medium and computer usable medium may refer to memories, such as the main memory 706 and the secondary memory 708, which may be a semiconductor memory such as dynamic RAMs. These computer program mediums may provide data that enables the computer system 700 to implement the method illustrated in FIG. 6. In an embodiment, the present invention is implemented using a computer/mobile implemented application. The computer implemented application may be stored in a computer program product and loaded into the computer system 700 using the removable storage drive or the hard disc drive in the secondary memory 708, the I/O port 710, or the communication interface 712.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 702, and a memory, such as the main memory 706 and the secondary memory 708, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present invention provide, among other features, systems and methods for allocating the vehicle to the passenger for the ride. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above, it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

What is claimed is:

1. A method for allocating a vehicle to a passenger for a ride, the method comprising:
receiving, by a server from a passenger device of the passenger over a communication network, an image corresponding to a destination address of a booking request for the vehicle;
determining, by the server, the destination address of the booking request based on the received image;
displaying, by the server on a display of the passenger device, the received image and determined destination address of the booking request;
receiving, by the server from the passenger device over the communication network, a confirmation message of the booking request based on the displayed image and destination address; and
allocating, by the server, the vehicle to the passenger for the ride in response to the received confirmation message.

2. The method of claim 1, further comprising providing, by the server on the passenger device over the communication network, a first library of images during the booking request by the passenger, wherein the image received by the server is selected from the first library of images by the passenger.

3. The method of claim 1, further comprising providing, by the server on the passenger device over the communication network, a second library of images during the booking request by the passenger, wherein each image of the second library of images is configured with a corresponding destination address by the passenger prior to the booking request, and wherein the image received by the server is selected from the second library of images by the passenger.

4. The method of claim 1, wherein the image received by the server is selected from a third library of images by the passenger, wherein the third library of images is stored in a memory of the passenger device.

5. The method of claim 1, wherein the image received by the server is a preview image by an image-capturing device of the passenger device, wherein the passenger of the passenger device provides an input to display the preview image by means of the image -capturing device.

6. The method of claim 1, further comprising executing, by the server, one or more image-based web portal searches based on the received image to determine the destination address of the booking request.

7. The method of claim 1, further comprising extracting, by the server, geo-tag information from the received image to determine the destination address of the booking request.

8. The method of claim 1, further comprising extracting, by the server, pre-configured information from the received image to determine the destination address of the booking request.

9. The method of claim 1, wherein the booking request further includes at least one of a source address, a time of travel, or a type of vehicle.

10. The method of claim 9, wherein the vehicle is allocated to the passenger based on the received booking request and the determined destination address after the reception of the confirmation message.

11. A system for allocating a vehicle to a passenger for a ride, the system comprising:
circuitry configured to:
receive, from a passenger device of the passenger over a communication network, an image corresponding to a destination address of a booking request for the vehicle;
determine the destination address of the booking request based on the received image;
display, on a display of the passenger device, the received image and the determined destination address of the booking request;
receive, from the passenger device over the communication network, a confirmation message of the booking request based on the displayed image and destination address; and
allocate the vehicle to the passenger for the ride in response to the received confirmation message.

12. The system of claim 11, wherein the circuitry is further configured to provide, on the passenger device over the communication network, a first library of images during the booking request by the passenger, wherein the received image is selected from the first library of images by the passenger.

13. The system of claim 11, wherein the circuitry is further configured to provide, on the passenger device over the communication network, a second library of images during the booking request by the passenger, wherein each image of the second library of images is configured with a corresponding destination address by the passenger prior to the booking request, and wherein the received image is selected from the second library of images by the passenger.

14. The system of claim 11, wherein the received image is selected from a third library of images by the passenger, wherein the third library of images is stored in a memory of the passenger device.

15. The system of claim 11, wherein the received image is a preview image by an image -capturing device of the passenger device, wherein the passenger of the passenger device provides an input to display the preview image by means of the image-capturing device.

16. The system of claim 11, wherein the circuitry is further configured to execute one or more image-based web portal searches based on the received image to determine the destination address of the booking request.

17. The system of claim 11, wherein the circuitry is further configured to extract geo-tag information from the received image to determine the destination address of the booking request.

18. The system of claim 11, wherein the circuitry is further configured to extract pre -configured information from the received image to determine the destination address of the booking request.

19. The system of claim 11, wherein the booking request further includes at least one of a source address, a time of travel, or a type of vehicle.

20. The system of claim 19, wherein the circuitry is further configured to allocate the vehicle to the passenger based on the received booking request and the determined destination address after the reception of the confirmation message.
